(19) United States
(12) Patent Application Publication
(10) Pub. No.: US 2003/0079597 A1
(43) Pub. Date: May 1, 2003

(54) Damped tensor ring

(76) Inventor: Jose Ignacio Vildosola Erdociain, Lodosa (ES)

Correspondence Address: OSTROLENK FABER GERB & SOFFEN, 1180 AVENUE OF THE AMERICAS, NEW YORK, NY, 100368403

(21) Appl. No.: 10/149,863

(22) PCT Filed: Dec. 12, 2000
(86) PCT No.: PCT/ES00/00467

(30) Foreign Application Priority Data
Dec. 17, 1999 (ES) P 9902756

(51) Int. Cl. G10D 9/02

(52) U.S. Cl. 84/383 R

(57) ABSTRACT

This consists of a spring (2.1) that raises or descends an turning the screw (2.2), which becomes endless to move the riveted nut (2.3) that, in turn, serves as a closure of the spring. On the point of the screw and the base of the spring two dampers (2.4 and 2.5) are fastened in such a way they permit the mouthpiece and reed of the wind instruments of the clarinet and saxophone families to be secured between both elements, touching the dampers only to avoid the transmission of vibrations to the set, thus reducing the contact surface with the results that the same set is valid for any instrument.

Possible changes in the shape and material of the spring (2.1) and the dampers (2.4 and 2.5) have been envisaged so that the way of tightening, the position and contact surface with the reed and mouthpiece can be varied.

### FIELD-OF-THE-ART

This invention consist of a new system for keeping the reed next to the mouthpiece in wind instruments of the clarinet and saxophone families, thanks to which great improvements are achieved as regards other system used up to now.

The improvements affect both the easiness provided when emitting low notes as well as the fullness of the sound.

### STATE-OF-THE-ART

A bracket system that maintains the reed fastened to the mouthpiece on reducing the diameter of the bracket when one or more screws are tightened has been used to date.

These systems have various disadvantages as a result of their design that affects the working and the sound of the instrument. Their basic characteristics are as follows: a bracket of a different size is needed for each member of the clarinet and saxophone families. When the mouthpiece and/or reed makes contact with the bracket, this receives part of its vibration trough transmission; the read becomes strangled against the mouthpiece when the diameter of the bracket is reduced, contrary to what would be ideal in maintaining it free of any pressure.

To avoid the inconveniences of this type, the owner of this invention has developed a new system to maintain the reed next to the mouthpiece, the main characteristics of which are as follows: the ring itself is valid for all the members of the clarinet and saxophone families; the reed and mouthpiece only come into contact with the damper of the spring and the screw and not with the spring; and the reed ascends from its base and maintained suspended underneath the mouthpiece without forcing.

### DESCRIPTION OF THE INVENTION

The cushioned tightener ring is composed of the following five components: spring (2.1), screw (2.2), riveted nut (2.3), damper of the screw (2.4) and damper of the spring (2.5).

The spring (2.1) is made of one wire part only with a design in the shape of a ring (3.1), slanted as regards the base (4.1), that ends up joining both ends in a head forming a gudgeon (5.1) that is attached with a riveted nut (2.3).

The riveted nut (2.3) closes the spring (2.1) and makes it rise or descend by sliding along the screw (2.2), which becomes endless when its point (8.1) turns on the damper (2.4) inserted in it so that it rests on the mouthpiece, managing to raise the base of the spring (4.1), which has another damper (2.5) inserted in it so that it rests on the reed with minimum contact, maintaining it suspended underneath the mouthpiece without forcing.

Due to the slant of the spring when it is made to rise on turning the screw, the back part of the base (4.2) is the first that rests on the reed, permitting the tension of the spring on the front part (4.3) to be adjusted and, consequently, the pressure of the reed on the front part.

### DESCRIPTION OF THE DRAWINGS

For a better understanding of the description in this report, attached are drawings in which a practical case of performance of the cushioned tightener ring and its components is represented as an example.

In said drawings,

FIG. 1 is an elevated view of the mounted set;

FIG. 2 is a lateral view of the mounted set;

FIG. 3 is an elevated view of the spring;

FIG. 4 is a lateral view of the spring;

FIG. 5 is a floor view of the spring;

FIG. 6 is an elevated view of the screw;

FIG. 7 is a floor view of the screw;

FIG. 8 is the A-A section of FIG. 7;

FIG. 9 is an elevated view of the screw damper;

FIG. 10 is a lateral view of the screw damper;

FIG. 11 is a floor view of the screw damper;

FIG. 12 is the A-A section of FIG. 11,

FIG. 13 is an elevated view of the spring damper;

FIG. 14 is a lateral view of the spring damper;

FIG. 15 is a floor view of the spring damper.

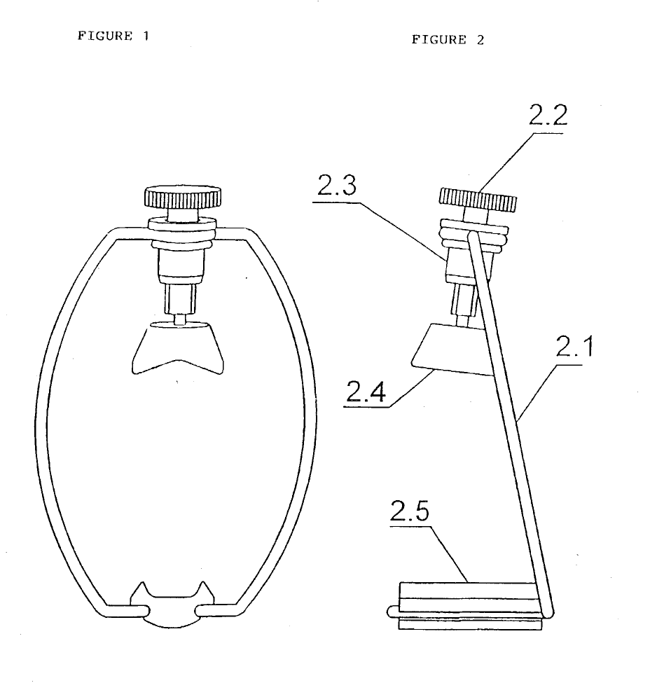

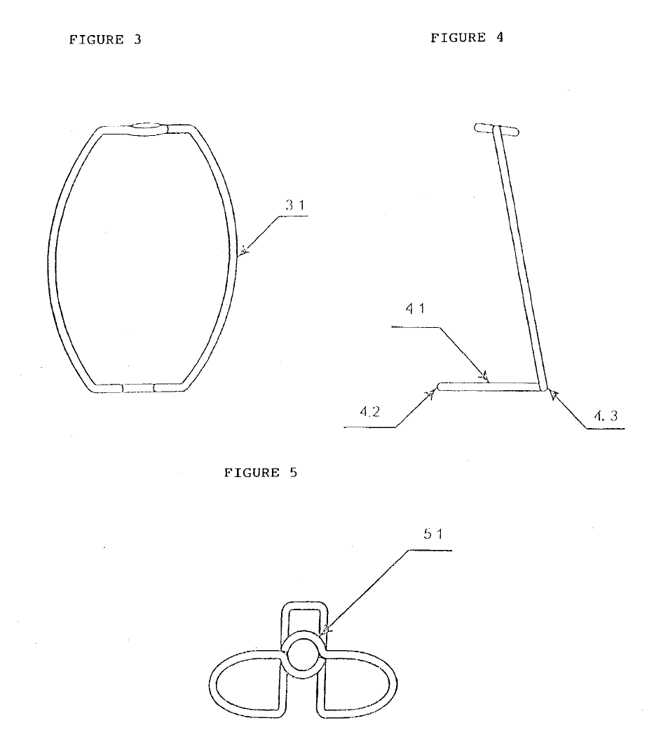

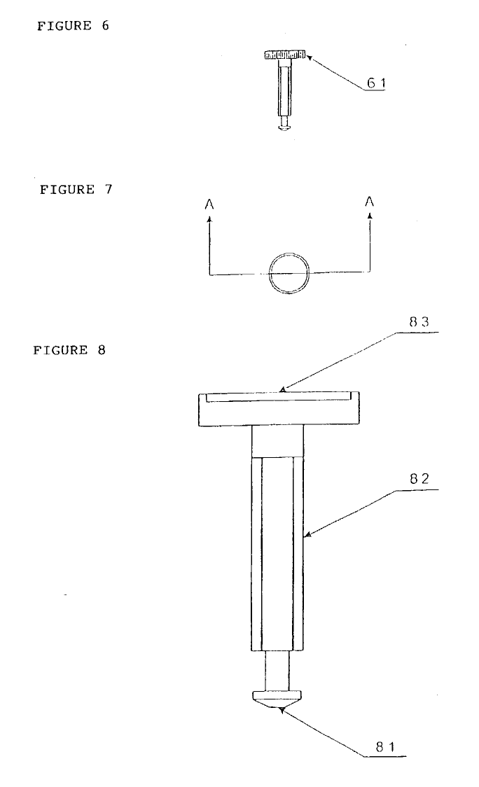

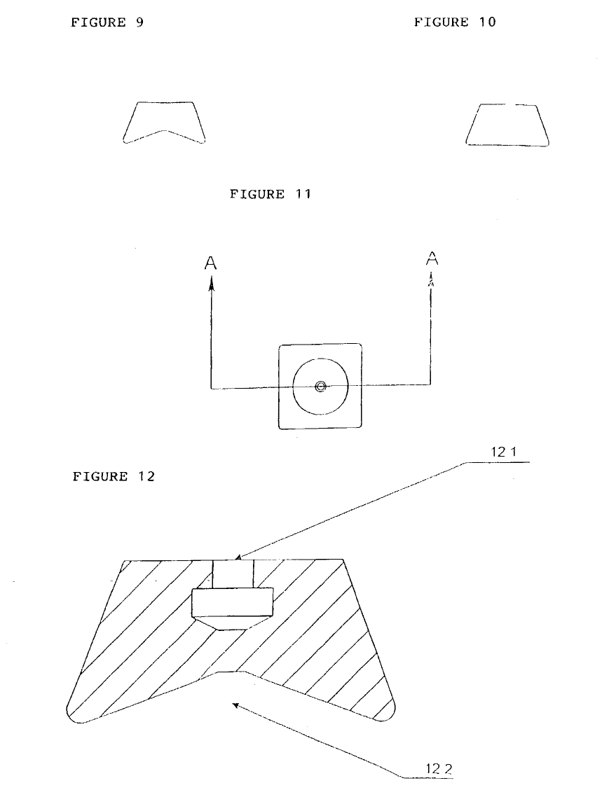

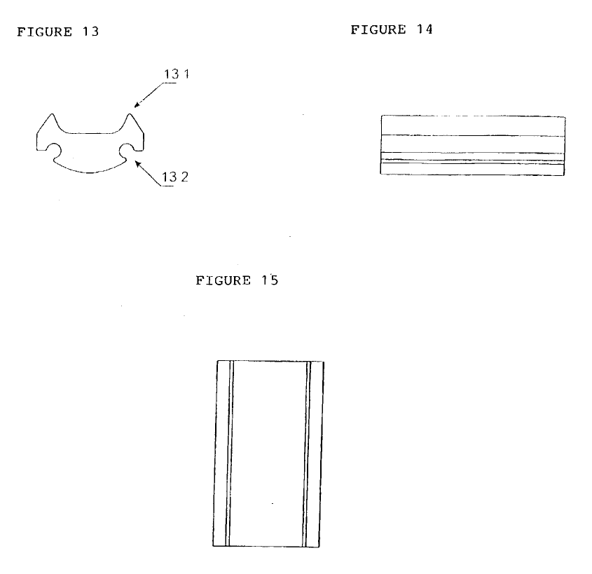

### WAY OF PERFORMANCE

The cushioned tightener ring in question consists of a spring (2.1) made of one metallic wire part only with a design in the shape of a ring (3.1) to avoid the contact with the mouthpiece. It has a base on is middle part (4.1) where the damper of the spring (2.5) can be inserted to end up next to both ends in ahead forming a gudgeon (5.1), which is attached with a standard riveted nut (2.3) with a flat head and cylindrical, polished and open body; a screw (2.2) made of plastic or turned metal coming out if the polished bar (6.1) to improve the contact with the fingers when it turns, with a screwed body (8.2), trough which the riveted nut (2.3) moves, in the shape of a point (8.1) where the damper of the screw (2.4) is inserted and turned and with a groove on the upper part of the head (8.3) for sticking or marking a distinctive sign; a damper (2.4) made of injected or hardness extruded EPDM between 70° and 90° shore with its upper part (12.1) shaped so that the point of the screw (8.1) can be inserted without preventing it turning. It has a base formed by two sloped planes (12.2) so that it can adapt to the different diameters of the mouthpiece and rest on them without moving; and a damper (2.5) made of extruded or hardness injected EPDM between 70° and 90° shore, with it upper part (13.1) formed by two relief lines where the reed rests and a base (13.2) that can be inserted into the base of the spring (4.1), which can be replaced by another damper with different point of contact with the reed.

1. Cushioned tightener ring comprising
a spring (2.1) in the shape of a ring for surrounding a reed and a mouthpiece without coming into contact with them,
a thread (2.3) on the upper part of the spring (2.1) allowing this to move through the action of a screw (2.2),
a first damper (2.4) inserted at the endpoint of the screw and which becomes endless when turned and resting perpendicularly on the mouthpiece and
a second damper (2.5) inserted in a raised base of the spring (2.1) which serves as a support for the reed, maintaining it suspended underneath the mouthpiece with minimum pressure so that it does not move.

2. Ring according to claim 1, characterized by the fact that the base of the spring (2.1) is formed on its middle part (4.1) opposite the thread (2.3) of the spring (2.1) and that the base is slanted acute-angled to the ring.

3. Ring according to claim 1 or 2, characterized by the fact that the thread (2.3) is formed by a riveted nut arranged on the upper part of the spring (2.1).

4. Ring according to claim 1, characterized by the fact that the first damper (2.4) is made of injected or extruded EPDM between 70° and 90° shore and has an upper part (12.1) shaped so that the endpoint (8.1) of the screw (2.2) can be inserted without preventing it turning and an under part formed by two sloped planes (12.2) so that it can adapt to different diameters of the mouthpiece and rest on them without moving.

5. Ring according to claim 1, characterized by the fact that the second damper (2.5) is made of extruded or injected EPDM between 70° and 90° shore and has an upper part (13.1) formed by two relief lines where the reed rests and a lower part (13.2) that can be insertet into the base of the spring (4.1).

6. Ring according to claim 1, characterized by the fact that this is used for members of the clarinet and saxophone families.
